(19) United States
(12) Patent Application Publication
(10) Pub. No.: US 2005/0062191 A1
(43) Pub. Date: Mar. 24, 2005

(54) Method and apparatus for molding rubber

(75) Inventors: Mitsuo Kurashige, Nishikasugai-gun (JP); Takum Narita, Nishikasugai-gun (JP); Tomoaki Okita, Nishikasugai-gun (JP); Gunpei Katsumura, Nishikasugai-gun (JP)

Correspondence Address: POSZ & BETHARDS, PLC, 11250 ROGER BACON DRIVE, SUITE 10, RESTON, VA, 20190, US

(73) Assignee: TOYODA GOSEI CO., LTD.

(21) Appl. No.: 10/940,015

(22) Filed: Sep. 14, 2004

(30) Foreign Application Priority Data
Sep. 22, 2003 (JP) 2003-329662

(51) Int. Cl. B29C 47/00

(52) U.S. Cl. 264/140; 425/204; 264/349; 425/376.1

(57) ABSTRACT

A two-axis continuous kneader 1 kneads a raw rubber, a reinforcing agent such as a carbon black, a softener such as a process oil, and the like by a screw, and at the same time sends them out in the front end direction and to the pelletizing/pellet delivery device 3. The pelletizing/pellet delivery device 3 manufactures the rubber pellet to be pressure-supplied to the extrusion molding device 15 through the conduit4. The extrusion molding device 15 kneads the rubber pellet supplied to the hopper 18 and the additive such as the vulcanized agent supplied to the hopper 19 by the screw to extrude the rubber pellet for a desired product.

The present application is based on Japanese patent application No. 2003-329662, the entire contents of which are incorporated herein by reference.

### BACKGROUND OF THE INVENTION

1 . Field of the Invention

The present invention relates to a method and an apparatus for molding rubber and in particular, to a method and an apparatus for molding rubber which performs operations from kneading of a rubber material to molding thereof based upon a series of steps.

2. The Related Art of the Invention

As an earlier method of molding a rubber product such as a tread of a tire or a weather strip for a vehicle there is generally adopted a method where raw rubber, a reinforcing agent, a filling agent, a softener are put in a kneader such as an intensive mixer for kneading, to mold a sheet and thereafter, this molded sheet, together with a vulcanized agent is put into a molding device to provide a product in a desired shape (for instance, weather strip).

Thus the earlier method is performed by a batch type kneading by using an intensive mixer or a kneader, which tends to cause deviations in a blending rate of materials used, and further needs a lot of labor forces, thereby to deteriorate productivity in molding a rubber product.

Also in order to reduce the deviations in the blending rate of the used materials or improve the productivity in molding the rubber product, a continuous kneading method for rubber molding is proposed, which includes a continuous kneader and an extrusion molding device connected to the continuous kneader (refer to Japanese Unexamined Patent Publication No. 2000-43032).

In a method described in this Patent Publication, a rubber supply opening is disposed in a base side of a barrel of the continuous kneader and an additive supply opening is disposed in a central portion thereof. A rubber supply device is connected through a metering gear pump to the rubber supply opening, a metering supply device for a vulcanized agent is connected to the additive supply opening, and an extrusion molding device is connected to a discharge-side end of the barrel. A sheet including raw rubber, a reinforcing agent, a filling agent, and a softener is supplied to the rubber supply device and an additive is added at the continuous kneader for kneading, to provide a rubber product in a desired shape through the extrusion molding device.

According to this method, due to continuously performing the operations from an addition of the vulcanized agent to the extrusion molding, deviations in the blending rate of the materials can be reduced and productivity in molding the rubber product can be improved.

According to the extrusion molding apparatus for continuous kneading described in the Patent Publication, however, since kneading of a non-vulcanizing rubber and a vulcanized agent in a kneading section each of which differs in a temperature condition and a product extrusion are continuously performed, an ideal result of product extrusion and an ideal result of vulcanizing can not be obtained.

And since the non-vulcanizing rubber is blended with the vulcanizing agent in the kneading section and thereafter, a product is extruded from the extrusion molding section directly connected to the kneading section, the only method of increasing a production amount is an increase of production speeds or production time, which provides the problem with lack of flexibility in productivity management.

### SUMMARY OF THE INVENTION

In view of the above, there exists a need for a method and an apparatus for molding rubber which overcomes the above-mentioned problems in the related art. The present invention addresses this need in the related art as well as other needs, which will become apparent to those skilled in the art from this disclosure.

Accordingly an object of the present invention is to provide a method and an apparatus for molding rubber, which can be adapted to both of small item large volume production and large item small volume production in manufacturing rubber products due to providing flexibility between each operation, and further restrict deviations in a blending rate of materials, and improve productivity in molding the rubber products.

The present invention is, in order to achieve the above-described object, to provide a method for molding rubber which comprises the steps of kneading a rubber material and a predetermined blending material to provide a rubber composition, pelletizing the rubber composition to provide a rubber pellet, delivering the rubber pellet to a predetermined position via a conduit under pressure; and extruding the rubber pellet to provide a product in a predetermined shape at the predetermined position.

The present invention is, in order to achieve the above-described object, to provide a method for molding rubber which comprises the steps of providing a rubber composition by kneading a rubber material and a predetermined blending material, forming a rubber pellet from the kneaded rubber composition, delivering the rubber pellet to a predetermined position via a conduit under pressure, and extruding the rubber pellet to form a product in a predetermined shape as an extrusion molding material by receiving the rubber pellet from the conduit connected at the predetermined position.

The delivering step may include delivering the rubber pellet to a plurality of predetermined positions under pressure, and the extrusion molding step may include extruding the rubber pellet to form the product in the predetermined shape as the extrusion molding material due to a plurality of extrusion molding devices connected to the conduit at the plurality of the predetermined positions.

The delivering step may include delivering the rubber pellet to a plurality of predetermined positions under pressure, and the extrusion molding step may include extruding the rubber pellet to form the product in the predetermined shape as the extrusion molding material due to a plurality of extrusion molding devices connected to the conduit at the plurality of the predetermined positions and at the same time receiving the rubber pellet at a delivery vessel connected at at least one of the plurality of the predetermined positions to the conduit.

And the present invention is, in order to achieve the above-described object, to provide a method for molding rubber which comprises the steps of providing a rubber composition by kneading a rubber material and a predetermined blending material, forming a rubber pellet from the kneaded rubber composition, delivering the rubber pellet to a predetermined position via a conduit under pressure, and storing the rubber pellet delivered under pressure through the conduit connected at the predetermined position.

The storing step may store the rubber pellet in a flexible container.

The storing step preferably stops supply of the rubber pellet to the flexible container when the flexible container reaches a predetermined weight.

The present invention is, in order to achieve the above-described object, to provide a method for molding rubber which comprises the steps of providing a rubber composition by kneading a rubber material and a predetermined blending material, forming a rubber pellet from the kneaded rubber composition, delivering the rubber pellet to a predetermined position by delivering the rubber pellet under pressure via the conduit, receiving the rubber pellet from the conduit connected at the predetermined position, and extruding the rubber pellet to form a product in a predetermined shape as an extrusion molding material by blending the received rubber pellet and an additive.

The delivering step may include delivering the rubber pellet to a plurality of predetermined positions under pressure, and the extrusion molding step may include extruding the rubber pellet to form the product in the predetermined shape as the extrusion molding material in a plurality of extrusion molding devices connected to the conduit at the plurality of the predetermined positions.

The extrusion molding step may add a vulcanized agent as the additive before extrusion molding.

The extrusion molding step may add a plurality of the additives including at least a vulcanized agent before extrusion molding.

The present invention is, in order to achieve the above-described object, to provide an apparatus for molding rubber which comprises a kneading section to form a rubber composition by kneading a rubber material and a predetermined blending material, a pellet-forming section to form a rubber pellet by pelletizing the kneaded rubber composition, a pellet delivery section to deliver the rubber pellet under pressure, and an extrusion molding section to extrude the rubber pellet to form a product in a predetermined shape by supply of the rubber pellet delivered under pressure through the pellet delivery section.

The pressure delivery section preferably includes a conduit equipped with a distributor including a distribution valve to control distribution of the rubber pellet to the extrusion molding section by opening/closing the distribution valve.

The extrusion molding section may include a plurality of the extrusion molding sections.

The extrusion molding section may extrude a two-color extrusion product based upon a two-color extrusion with an extrusion member extruded from another extrusion molding device.

The pressure delivery section may include a storage tank to store the rubber pellet temporarily.

According to the present invention a rubber composition produced by kneading a rubber material and a predetermined blending material is made to be pelletted to provide a rubber pellet and this rubber pellet is delivered under pressure to an extrusion molding section by a pellet delivery section. Accordingly, flexibility between processes becomes possible, so that the present invention can be adapted to both a small item large volume production and large item small volume production and further, restrict deviations in a blending composition and yet to improve productivity in molding a rubber product.

These and other objects, features, aspects and advantages of the present invention will be become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is an entire view showing an apparatus for manufacturing an extrusion molding product of a first embodiment according to the present invention;

FIG. 2 is an enlarged explanation view of a pelletizing/pellet delivery device;

FIG. 3 is a control block diagram of the apparatus for manufacturing the extrusion molding product;

FIG. 4 is a view showing another supply of a rubber pellet by a delivery vessel;

FIG. 5A is a view showing supply of a rubber pellet from a different delivery vessel;

FIG. 5B is a view showing supply of the rubber pellet from the delivery vessel in FIG. 5A;

FIG. 6 is an entire view showing an apparatus for manufacturing an extrusion molding product of a second embodiment according to the present invention;

FIG. 7A is an entire view showing an apparatus for manufacturing an extrusion molding product of a third embodiment according to the present invention;

FIG. 7B is an enlarged view of a part in FIG. 7A; and

FIG. 8 shows a cross sectional view of a weather strip manufactured based upon the third embodiment.

### DETAILED DESCRIPTION OF THE PREFERRED EMBODIMENTS

Selected embodiments of the present invention will now be explained with reference to the drawings. It will be apparent to those skilled in the art from this disclosure that the following description of the embodiments of the present invention is provided for illustration only, and not for the purpose of limiting the invention as defined by the appended claims and their equivalents.

### FIRST EMBODIMENT

Embodiments of the present invention will be explained with reference to accompanying drawings as follows.

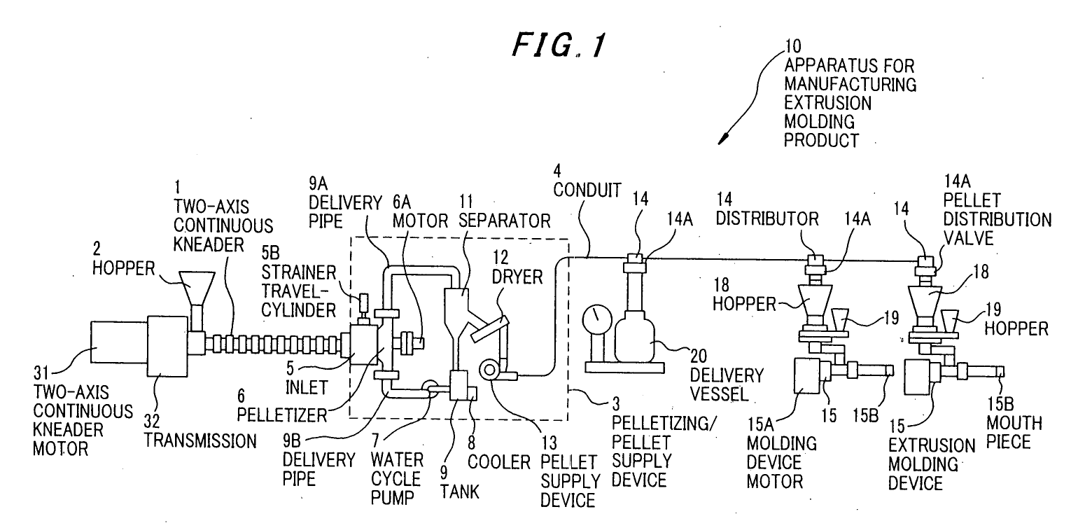

FIG. 1 is an entire construction view of an apparatus for manufacturing an extrusion molding product according to a first embodiment. The apparatus 10 for manufacturing the extrusion molding product includes a two-axis continuous kneading device 1, a hopper 2 as a supply port of raw rubber or the like, a two-axis continuous kneading device motor 31 providing rotation to a screw (not shown), a transmission 32 changing a screw rotation speed, a pelletizing/pellet delivery device 3, a pipe 4 equipped with a plurality of distributors 14 which distribute a pellet of a kneaded rubber composition conveyed though the pipe, a plurality of extrusion molding device 15 connected to the pipe 4 through the distributors 14, and a delivery vessel 20.

The distributor 14 includes a pellet distribution valve 14A which is controlled to be opened/closed by an actuator, and distributes a rubber pellet delivered under pressure inside the pipe 4 to an extrusion molding device 15 and a delivery vessel 20.

The extrusion molding device 15 is constructed of one screw, which includes a molding device motor 15A, an outlet 15B to discharge an extrusion material, a hopper 18 for rubber pellet supply, and a supply hopper 19 for additives.

The delivery vessel 20 is, for instance, a bag-like flexible container having flexibility, and temporarily stores the rubber pellet and beside, wraps the rubber pellet, thereby to be delivered to other locations. The delivery vessel 20 checks a quantity of the rubber pellet in a weight measure in storing the rubber pellet (timing of supply), and stops the storing if the rubber pellet reaches a predetermined value in weight.

The pelletizing/pellet delivery device 3 produces the rubber pellet by pelletizing the kneaded rubber composition blended in the two-axis continuous mixer 1, and delivers the rubber pellet to the pipe 4 described later.

The pelletizing/pellet delivery device 3 includes an inlet 5 of the kneaded rubber composition, a pelletizer 6, a water cycle pump 7, a cooker 8, a tank 9, a delivery pipes 9A, 9B, a separator 11, a dryer 12, and a pellet delivery device 13.

The inlet 5 removes a flocculation body, gels, foreign matters contained in the kneaded rubber composition supplied from the two-axis continuous kneader 1, and impure ingredients to cause a product defective in extrusion molding, as well as supplies to the pelletizer 6 at a later stage the kneaded rubber composition the impure ingredient of which is removed, and includes a strainer travel-cylinder 5B to travel a strainer (described later) used for removal of the impure ingredient to a predetermined direction.

The pelletizer 6 forms the rubber pellet by dividing the kneaded rubber composition extruded in a string shape to particles.

The water cycle pump 7 circulates cooling water in a path of the delivery pipe 9B, the pelletizer 6, a delivery pipe 9A, the separator 11, and the tank 9. The cooling water may have a separating performance due to kneading a separator agent thereto.

The separator 11 separates the rubber pellet from the mixture of the rubber pellet and the cooling water to supply the separated rubber pellet to the dryer 11.

The dryer 12 exposes a wet rubber pellet supplied from the separator 11 to an air stream to forcibly dry the wet rubber pellet.

The pellet delivery device 13 is connected to the pipe 4 for delivering the rubber pellet under pressure, and the pipe 4 is connected to the extrusion molding device 15 and the delivery vessel 20 through the distributor 14.

In addition, the pellet delivery device 13 is designed to supply dried air to the pipe 4, but may supply a normal air or an inactive gas such as nitrogen.

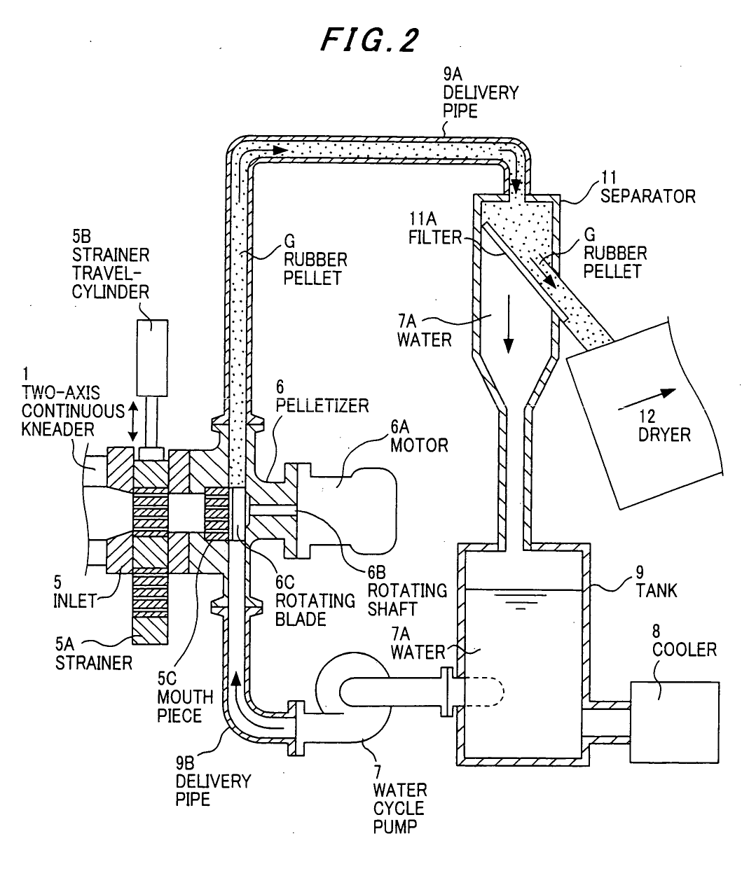

FIG. 2 is an enlarged explanation view by cutting a part of the pelletizing/pellet delivery device.

The inlet 5 includes the strainer 5A supported by the strainer travel-cylinder 5B in the direction perpendicular to an extrusion direction of the kneaded rubber composition, namely in a vertical direction in FIG. 2 and the outlet 5C to extrude kneaded rubber composition like a string.

The pelletizer 6 includes a motor 6A, a rotating blade 6C mounted to a rotational shaft 6B of the motor 6A where the string-like kneaded rubber composition extruded from the outlet 5c in the inlet 5 is divided by rotating the rotating blade 6c with the motor 6A, to form the rubber pellet G.

The rotating blade 6C is cooled by water 7A delivered by the delivery pipe 9B, as well as is designed to send out to the delivery pipe 9A connected to the downstream side the rubber pellet G together with the water 7A.

The rubber pellet G is delivered to the separator 11 from the pelletizer 6 through the delivery pipe 9A by the water 7A delivered under pressure from the water cycle pump 7, and then, is separated from the water 7A therein. Then water components attached to the rubber pellet G are removed in the dryer 12 and thereafter, the rubber pellet G is delivered from the pellet supply device 13 to the conduit 4.

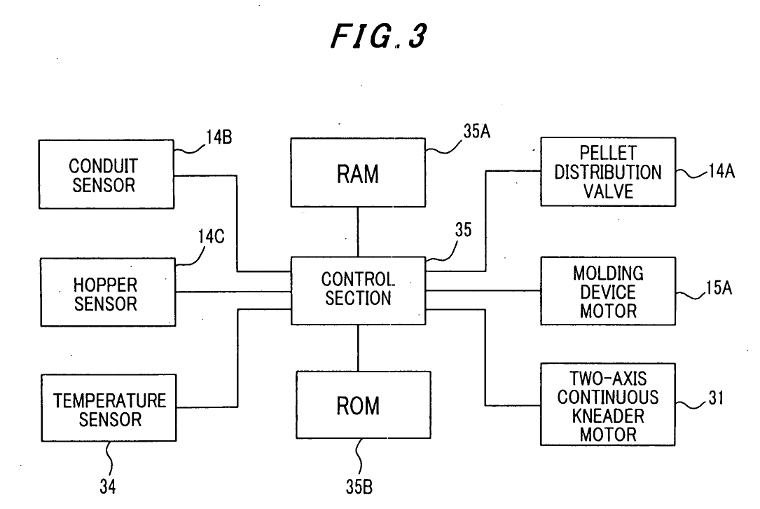

FIG. 3 is a control block diagram of the apparatus for manufacturing the extrusion molding product. The apparatus 10 for manufacturing the extrusion molding product include a pipe sensor 14B disposed in the pipe 4, a hopper sensor 14 disposed in the hopper 18 to detect a rubber pellet weight based upon a quantity of the rubber pellet G supplied through the pipe 4, a temperature sensor 34 which checks temperature of the two-axis continuous kneader 1 and the extrusion molding device 15, a RAM 35 which temporality stores detection data of each sensor, a ROM which stores control programs to control an operation of each section in each process, and a control section to control each section.

The hopper sensor 14C outputs a supplementary signal to the control section 35 when the rubber pellet G received in the hopper 18 reaches a predetermined lower limit quantity. The supplementary signal is lifted when a supply quantity of the rubber pellet G goes beyond the lower limit quantity. And the hopper sensor 14C outputs a supplementary stop signal to the control section 35.

When the rubber pellet G received in the hopper 18 reaches a predetermined upper limit quantity. However, even if the extrusion molding device 15 receives the supplementary signal, the hopper 18 includes the rubber pellet G which can operate for a certain period of tine.

The control section 35 performs controls to open/close the pellet distribution valve 14A, to start/stop the molding device motor 15A, And to start/stop the two-axis kneader motor 31.

And the control section 35 receives an input of the supplementary signal from the hopper sensor 14c, to open the pellet distribution valve 14A of the corresponding extrusion molding device 15. However, when supplementary signals are inputted from two or more the hopper sensors 14C at the same timing, the control section 35 opens the pellet distribution valve 14A of the extrusion molding device 15 based upon a predetermined priority condition.

An operation of the first embodiment will be explained as follows.

First, a raw material such as an ethylene propylene diene terpolymer (EPDM) which is a thermoplastic elastomer, a reinforing agent such as a carbon black, and a softener such as a process oil (collectively referred to as rubber composition) are supplied to the two-axis continuous kneader 1 from the hopper 2 by a supply device (not shown). The rubber composition is kneaded by a screw (not shown) housed in the two-axis continuous kneader 1 to form the kneaded rubber composition, which is delivered to a front end direction of the two-axis continuous kneader 1.

The kneaded rubber composition kneaded by the two-axis continuous kneader 1 is extruded in a string shape from the pipe sleeve 5c to be supplied to a pelletizer 6. The pelletizer 6 divides the kneading rubber kneader in a string shape granularly to form the rubber pellet G. The rubber pellet G is delivered inside a delivery pipe 9A by water supplied from the water cycle pump 7 as well as cooled therein, and then supplied to the separator 11. The separator 11 separates the rubber pellet from water, which is supplied to the dryer 12. The dryer 12 removes water components attached to the rubber pellet G, which then is delivered to the pellet delivery device 13. The pellet delivery device 13 sends out the rubber pellet G to the conduit 4 at a predetermined air pressure. However, the air to supply under pressure the rubber pellet G is preferably unwatered and may include nitrogen for preventing deterioration of the rubber pellet G.

The rubber pellet G which is supplied under pressure via the conduit 4 is supplied to the extrusion molding device 15 through the distributor 14. The extrusion molding device 15 kneads the rubber pellet G supplied to the hopper 18 and additives such as a vulcanized agent supplied to the hopper 19 based upon rotation of the screw (not shown) to be formed as a vulcanized rubber, which is extruded as a desired product from the mouth piece 15B.

And the rubber pellet G which is supplied under pressure through the conduit 4 is not necessary to be supplied to the extrusion molding device 15, and also is supplied and temporarily stored in the delivery vessel 20 through the distributor 14 when the weight checked with regard to the delivery vessel 20 does not reach a predetermined value.

However, the extrusion molding product-manufacturing apparatus of the first embodiment can be applied to manufacture of various rubber products, and particularly suited for manufacture of a weather strip, which will be explained as follows. The raw rubber having 100 in weight, the carbon black having 50-300 in weight to the raw rubber, the process oil having 10-40 in weight to the raw rubber and other filling agents are supplied to the two-axis continuous kneader 1.

As raw rubbers there are EOR (ethylene olefin rubber) NR (natural rubber), IR (isoprene rubber), SBR (styrene butadiene rubber), BR (butadiene rubber), CR (chloroprene rubber), IIR (butyl rubber), CO/ECO (epichlorohydrin rubber), NBR (nitryl rubber), ACM/ANM (acrylic rubber), FKM (fluorine rubber), Q (silicone rubber) or the like. The EOR is suited for the weather strip and in particular EPDM (ethylene propylenedieneter polymer is best suited for it. The EPDM preferably includes ethylene content 60-80 in weight %, propylene content 25-35 in weight %, and unconjugated diene content equal to or less than 5 in weight %.

Any of HAF, MAF, FEF, GPF, and SRF can be used as the carbon black, but MAF, FEF, and GPF are preferable for securing extrusion processing performance and reinforcing performance.

As the other filling agents supplied to the two-axis continuous kneader 1 there are a white color filling agent (clay, calcium carbonate, silica or the like), a lubricant (stearic acid), a zinc oxide, and a dehydrating agent (calcium oxide or the like).

The various components supplied to the two-axis continuous kneader 1 are kneaded and are extruded as the kneaded rubber composition in a string shape from the mouth piece 5C. This string-shaped kneading rubber composition is separated by the rotating blade 6C of the pelletizer 6 to become the rubber pellet. The rubber pellet is delivered through the conduit and supplied to the extrusion molding device 15 where the vulcanized agent and a vulcanization-promoting agent are added to the rubber pellet for kneading, to be molded in a weather strip shape. In case a sulfuric vulcanized agent is used as the vulcanized agent, any of thiazole, thiram, and dithiocarbamate vulcanized agents is chosen.

It is preferable that blending components other than the vulcanized agents and the vulcanization-promoting agents all are supplied to the two-axis continuous kneader 1 for kneading, but if these agents are extremely small in quantity, the blending of the white color filling agents and the zinc oxide may be performed in the extrusion molding device 15, not the two-axis continuous kneader 1. In addition, in case the blending of the white color filling agents and the zinc oxide is performed in the extrusion molding device 15, it is preferable in view of kneading dispersion performance that the vulcanized agents and the vulcanization-promoting agents are blended while carried by the filling agents.

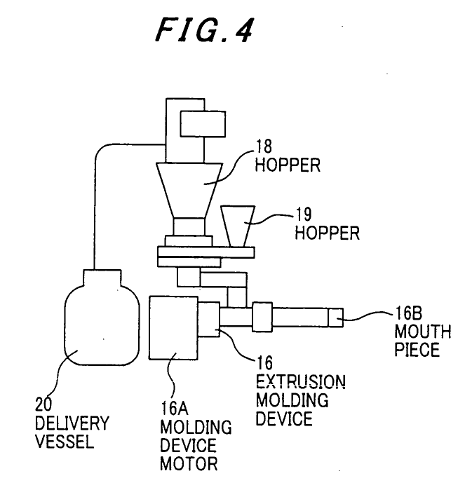

FIG. 4 is a view showing supply of the rubber pellet by the delivery vessel. Thus it is possible to supply the rubber pellet G from the delivery vessel 20 to the extrusion molding device 16 which is not connected to the conduit 4. In the extrusion molding device 16, a desired product can be extruded from the mouth piece 16B by driving a molding device motor 16A.

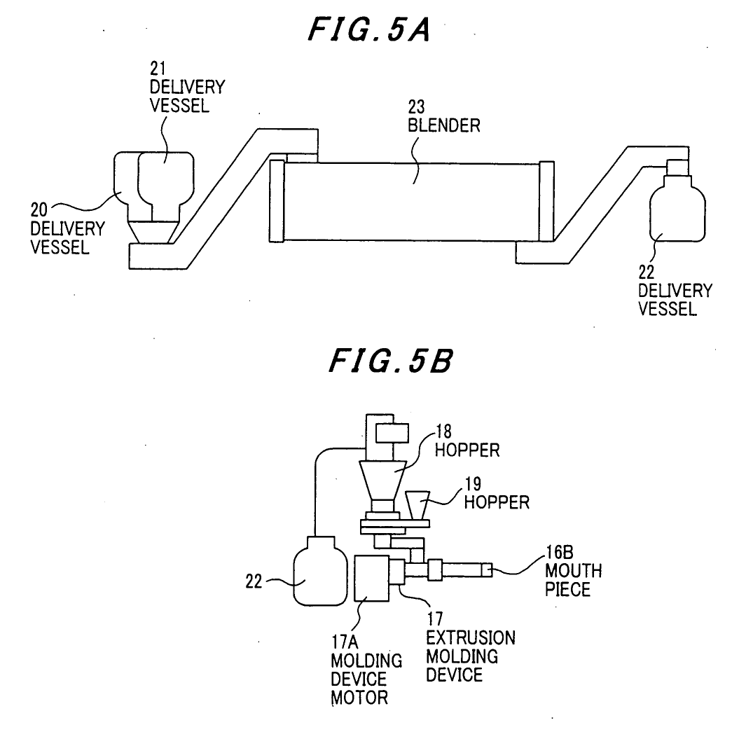

FIGS. 5A and 5B are views showing another supply of the rubber pellet by the delivery vessel. In this method, the delivery vessel 20 and a different vessel 21 both are mounted to a blender 23 and the rubber pellet G supplied from the delivery vessel 20 and the rubber pellet G having a different blending composition supplied from the other delivery vessel 21 are blended in the blender 23 to be supplied to the delivery vessel 22. The delivery vessel 22, as shown in FIG. 5B, is mounted to the extrusion molding device 17. In the extrusion molding device 17, a desired product can be formed by extruding the blended rubber pellet G from the mouth piece 17B by driving a molding device motor 16A.

According to the first embodiment, the following effects can be obtained.

(1) Since the kneaded rubber composition are produced at the two-axis continuous kneader 1 based upon an appropriate condition (temperature, time, speed), and the kneaded rubber composition is pelletted to be a common raw material, the kneaded rubber composition with the optimized kneading condition can be formed.

(2) Since the common raw material is pelletted and the pelletted raw material is pressure-supplied to a plurality of supply sides (extrusion molding device 15, delivery vessel 20) via the conduit 4, the rubber pellet G is delivered with the rubber pellet G still hermetically closed, which enables minimizing a quality deterioration of the rubber product after manufacture. And since the rubber pellet G based upon the kneaded rubber composition formed in the two-axis continuous kneader 1 can be continuously supplied, it is possible to continuously supply the rubber pellet G with a stable quality preventing the deviation in the blending composition.

(3) Since the rubber pellet G is supplied under pressure with the rubber pellet G closed from light, deterioration of the rubber pellet G due to light irradiation does not occur easily.

(4) Since the distributor 14A equipped with the pellet distribution valve 14A is disposed in the conduit 4 which supplies the rubber pellet G, the rubber pellet G is easily supplied to the supply side corresponding to the number of the extrusion molding device 15 and the number of the delivery vessel 20, to improve flexibility between each process and as a result a flexible reply to large item small volume production is possible. And the productivity of the rubber product can be improved.

(5) Since the rubber pellet G is distributed through the conduit 4, and thereby the rubber pellet G can be distributed not only to the extrusion molding device 15 but also the delivery vessel 20, the rubber pellet G can be temporarily stored in the delivery vessel 20 depending on the situations. And the extrusion molding device 15 which is not connected can be supplied and a proper quantity of the rubber pellet can be supplied corresponding to an application of performing a small volume production. And since the rubber pellet G does not contain the vulcanized agent, the stored rubber pellet does not deteriorate in quality.

(6) Since it is possible to blend and extrude various rubber pellets G stored in the delivery vessel 20 by a different extrusion molding device 15, diversification of extrusion products can be performed flexibly.

(7) Since, in forming an extrusion molded material, the rubber pellet G formed continuously from the kneaded rubber composition and the additives are blended in the extrusion molding device 15, a blending performance between the rubber. pellet G with small deterioration in quality, and the additives becomes uniform and stable, to provide a product with a stable quality.

(8) Since the rubber pellet G with a small deviation in quality is supplied through the conduit 4, even in case an additive (for example, calcium carbonate, silica ) other than a vulcanized agent is blended in the extrusion molding device 15 as a supply end, a uniform blending state with a stable quality can be obtained.

(9) Since the rubber pellet G can be distributed to a plurality of extrusion molding device 15 through the conduit 4, it is possible to cut down on the number of carriers and work force to deliver the rubber pellet G, to reduce manufacturing costs.

### SECOND EMBODIMENT

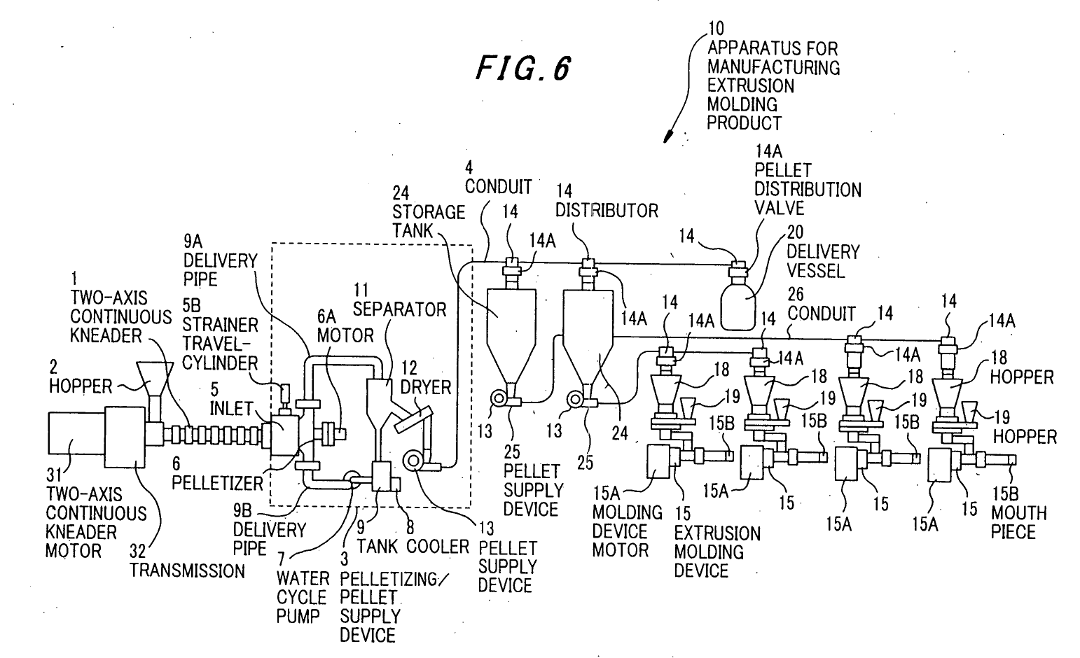

FIG. 6 is an entire construction view of an apparatus for manufacturing an extrusion molding product of a second embodiment. In the following explanation, components in the second embodiment identical to those in the first embodiment are referred to as identical numerals. The second embodiment differs from the first embodiment in that a storage tank 24 is connected through the distributor 14 to the conduit 4, the conduit 4 is connected to a pellet delivery device 25 disposed under the storage tank 24, and the extrusion molding device 15 is connected through the distributor 14.

Accordingly the pellet from the pelletizing/pellet delivery device 3 is stored in the storage tank 24 through the distributor 14, delivered under pressure in the pellet delivery device 25 to be delivered inside the conduit 4 and then supplied to the extrusion molding device 15.

An operation of the second embodiment will be explained as follows.

The two-axis continuous kneader 1 forms the kneading rubber composition by kneading the raw rubber supplied from the hopper 2 by the supply apparatus (not shown), the reinforcing agent such as a carbon black, and the softener such as a process oil by the screw and the kneaded rubber composition is delivered to the pelletted/pellet-delivery device 3. The pelletizing/pellet delivery device 3 forms the rubber pellet from the kneaded rubber composition and send out it to the conduit 4 according to the procedures explained in the first embodiment.

The rubber pellet is supplied under pressure in the conduit 4 and stored in the storage tank 24 through the distributor 14. The rubber pellet stored in the storage tank 24 is supplied to the conduit 26 by the pellet delivery device 25, and then to the extrusion molding device 15 through the distributor 14. The extrusion molding device 15 kneads the rubber pellet supplied to the hopper 18 and the additive such as the vulcanized agent supplied the hopper 19 based upon rotation of the screw (not shown), and extrudes a desired product as the vulcanized rubber from the mouth piece 15B.

According to the above second embodiment, due to disposition of the storage tank 24, flexibility between each process can be increased in addition of the preferred effects in the first embodiment. For example, the rubber pellet is, in advance, stored in the storage tank and then the extrusion molding device is driven. On this occasion, even if a use quantity of the rubber pellet at the extrusion molding device goes beyond the capability of the two-axis continuous kneader 1, the continuous working is possible.

### THIRD EMBODIMENT

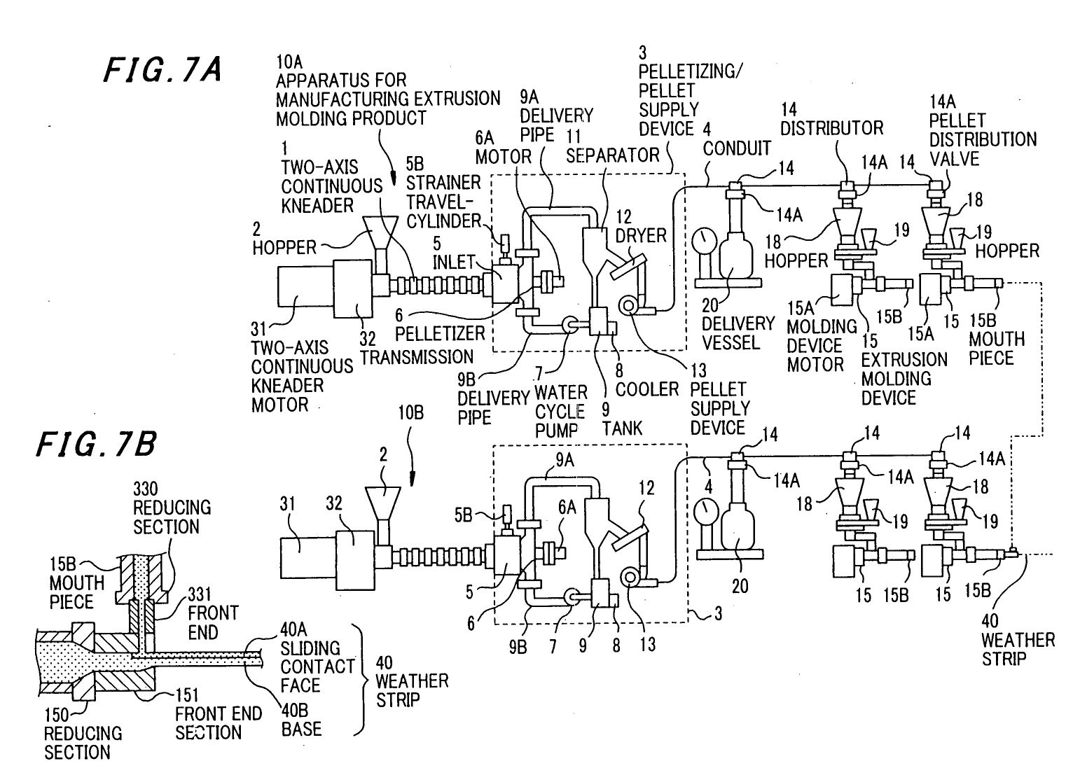

FIG. 7A is an entire construction view of an apparatus for manufacturing an extrusion molding product according to a third embodiment. FIG. 7B is an enlarged view of a part in FIG. 7A. In the third embodiment, as shown in FIG. 7A, the apparatuses 10A, 10B for manufacturing the extrusion molding product are installed. An extrusion opening 15B of the extrusion molding device 15 in one apparatus 10A for manufacturing the extrusion molding product and an extrusion opening 15B of the extrusion molding device 15 in the other apparatus 10B for manufacturing the extrusion molding product are connected to a common front end 151 as shown in FIG. 7B to form a weather strip 40 including a sliding contact face 40A on a surface of the base 40B. Namely the apparatus 10A for manufacturing the extrusion molding product supplies the rubber material from the mouth piece 15b through a reduced section 330 and a front end 331 to form the sliding contact face 40A and on the other hand, the apparatus 10B for manufacturing the extrusion molding product supplies the rubber material through a reduced section 150 to form the sliding contact face 40B. Thereby the weather strip 40 having the sliding contact face 40A on the surface of the base 40B is extruded from a front end 151 of the mouth piece 15B of the apparatus 10B for manufacturing the extrusion molding product.

In detail, a dynamic vulcanization is performed by, in advance, kneading the EPDM, the vulcanized agent, the filling agent, the process oil, and the polypropylene in a predetermined ratio, to prepare the pellet material. Next, the pellet material is kneaded at the two-axis continuous kneader 1 of the apparatus 10A for manufacturing the extrusion molding product, and at the pelletizing/pellet delivery device 3, the thermoplastic elastomer (TPO) pellet (B) is formed as well as the TPO pellet (B) is supplied under pressure to the conduit 4. The TPO pellet (A) is supplied to the extrusion molding device 15 via the conduit 4 in a side of the apparatus 10A for manufacturing the extrusion molding product, and the distributor 14, and these two materials are two-color extruded from the mouth piece 151 at a molten state to form the weather strip 40.

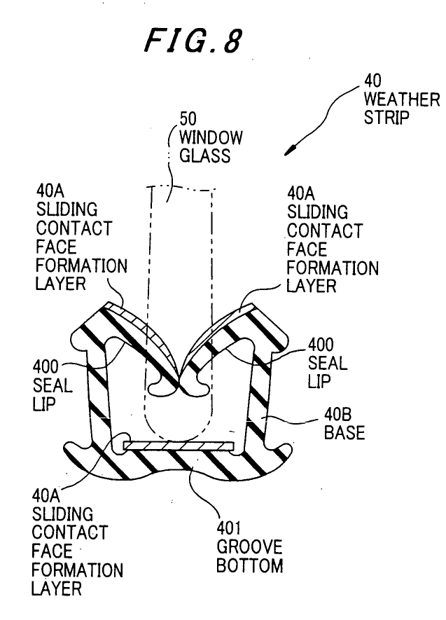

FIG. 8 shows a cross sectional view of the weather strip manufactured based upon the third embodiment. The weather strip 40 includes a seal lip 400 extruded having the TPO pellet (B) as a raw material, a groove bottom 401, and the base 40B. And the sliding contact face 40A extruded having the TPO pellet (A) as a raw material is integrally extruded thinly on the seal lip 400 and on the surface of the groove bottom 401.

According to the above third embodiment, the weather strip 40 includes the sliding contact face 40A having a higher hardness than the seal lip 400, the groove bottom 401, and the base 40B, and a good sliding performance with a window glass, and the groove bottom 401. The weather strip 40 can be easily two-color extruded, and also the processes from supply of the raw material constituting the weather strip to the extrusion molding of the weather strip are continuously performed.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

1. A method for molding rubber, comprising steps of:
kneading a rubber material and a predetermined blending material to provide a rubber composition;
pelletizing the rubber composition to provide a rubber pellet;
delivering the rubber pellet to a predetermined position via a conduit under pressure; and
extruding the rubber pellet to provide a product in a predetermined shape at the predetermined position.

2. A method for molding rubber, comprising the steps of:
providing a rubber composition by kneading a rubber material and a predetermined blending material;
forming a rubber pellet from the kneaded rubber composition;
delivering the rubber pellet to a predetermined position via a conduit under pressure; and
extruding the rubber pellet to form a product in a predetermined shape as an extrusion molding material by receiving the rubber pellet from the conduit connected at the predetermined position.

3. The method as defined in claim 1, wherein
the delivering step includes:
delivering the rubber pellet to a plurality of predetermined positions under pressure; and
the extrusion molding step includes:
extruding the rubber pellet to form the product in the predetermined shape as an extrusion molding material due to a plurality of extrusion molding devices connected to the conduit at the plurality of the predetermined positions.

4. The method as defined in claim 1, wherein
the delivering step includes:
delivering the rubber pellet to a plurality of predetermined positions under pressure; and
the extrusion molding step includes:
extruding the rubber pellet in the predetermined shape as an extrusion molding material due to a plurality of extrusion molding devices connected to the conduit at the plurality of the predetermined positions; and
at the same time receiving the rubber pellet at a delivery vessel connected at at least one of the plurality of the predetermined positions to the conduit.

5. A method for molding rubber, comprising the steps of:
providing a rubber composition by kneading a rubber material and a predetermined blending material;
forming a rubber pellet from the kneaded rubber composition;
delivering the rubber pellet to a predetermined position via a conduit under pressure; and
storing the rubber pellet delivered under pressure through the conduit connected at the predetermined position.

6. The method as defined in claim 5, wherein
the storing step stores the rubber pellet in a flexible container.

7. The method as defined in claim 6, wherein
the storing step stops supply of the rubber pellet to the flexible container when the flexible container reaches a predetermined weight.

8. A method for molding rubber, comprising the steps of:
providing a rubber composition by kneading a rubber material and a predetermined blending material;
forming a rubber pellet from the kneaded rubber composition;
delivering the rubber pellet to a predetermined position by delivering the rubber pellet under pressure via the conduit;
receiving the rubber pellet from the conduit connected at the predetermined position; and
extruding the rubber pellet to form a product in a predetermined shape as an extrusion molding material by blending the received rubber pellet and an additive.

9. The method as defined in claim 8, wherein the delivering step includes:
delivering the rubber pellet to a plurality of predetermined positions under pressure; and
the extrusion molding step includes:
extruding the rubber pellet to form the product in the predetermined shape as the extrusion molding material in a plurality of extrusion molding devices connected to the conduit at the plurality of the predetermined positions.

10. The method as defined in claim 8, wherein
the extrusion molding step adds a vulcanized agent as the additive before extrusion molding.

11. The method as defined in claim 8, wherein
the extrusion molding step adds a plurality of the additives including at least a vulcanized agent before extrusion molding.

12. An apparatus for molding rubber, comprising:
a kneading section to form a rubber composition by kneading a rubber material and a predetermined blending material;
a pellet-forming section to form a rubber pellet by pelletizing the kneaded rubber composition;
a pellet delivery section to deliver the rubber pellet under pressure; and
an extrusion molding section to extrude the rubber pellet to form a product in a predetermined shape by supply of the rubber pellet delivered under pressure through the pellet delivery section.

13. The apparatus as defined in claim 12, wherein
the pellet delivery section includes a conduit equipped with a distributor including a distribution valve to control distribution of the rubber pellet to the extrusion molding section by opening/closing the distribution valve.

14. The apparatus as defined in claim 12, wherein
the extrusion molding section includes a plurality of the extrusion molding sections.

15. The apparatus as defined in claim 12, wherein
the extrusion molding section extrudes a two-color extrusion product based upon a two-color extrusion wherein extrusion member extruded from another extrusion molding device.

16. The apparatus as defined in claim 12, wherein
the pellet delivery section includes a storage tank to store the rubber pellet temporarily.
